(19) United States
(12) Patent Application Publication
(10) Pub. No.: US 2005/0166883 A1
(43) Pub. Date: Aug. 4, 2005

(54) Internal combustion engine and method for the operation thereof

(76) Inventors: Normann Freisinger, Lorch (DE); Martin Matt, Bruchsal-Untergrombach (DE); Jorg Weingartner, Winnenden (DE)

Correspondence Address: KLAUS J. BACH, 4407 TWIN OAKS DRIVE, MURRYSVILLE, PA, 15668, US

(21) Appl. No.: 11/073,041

(22) Filed: Mar. 4, 2005

Related U.S. Application Data
(63) Continuation-in-part of application No. PCT/EP03/09276, filed on Aug. 21, 2003.

(30) Foreign Application Priority Data
Sep. 6, 2002 (DE) 102 41 443.2

(51) Int. Cl. F02N 17/00

(52) U.S. Cl. 123/179.4; 701/112

(57) ABSTRACT

In an internal combustion engine for a motor vehicle, comprising a starter system and a control system for controlling the internal combustion engine, the control system of the internal combustion engine is configured for a defined coast down of the internal combustion engine, by means of which pollutants that are left in the internal combustion engine are fed to the catalytic converter system for afterburning, while the control system actuates the starter system for a specific first period of time following a last combustion event in a combustion chamber.

This is a Continuation-In-Part Application of International Application PCT/EP03/09276 filed Aug. 21, 2003 and claiming the priority of German application 102 41 443.2 filed Sep. 6, 2002.

### BACKGROUND OF THE INVENTION

The invention relates to an internal combustion engine with a cylinder block with pistons a crankcase with a crankshaft and a cylinder head with intake and exhaust passages and to a method of operating the engine.

Such internal combustion engines are well-known. Internal combustion engine generally comprise a cylinder head with a cylinder block and a crankcase with a crankshaft connected to several pistons disposed in the cylinder block and delimiting therein combustion chambers. The cylinder head further includes intake passages in communication with an air intake duct for supplying combustion air or a fuel/air mixture to the combustion chambers. Generally, fuel is injected into the intake passages by means of injection nozzles and inlet valves are provided in the cylinder head for closing the inlet passages. For controlling the air supply to the combustion chambers, a throttle valve is arranged in the air intake duct. The cylinder head also includes several exhaust passages connected to an exhaust duct for discharging the exhaust gases generated in the combustion chambers to a catalytic converter system disposed in the exhaust duct. Each of the exhaust passages can also be closed or opened by an exhaust valve arranged in the cylinder head. For the crankshaft rotatably supported in the crankcase a starter system is provided for starting the internal combustion engine. Furthermore, a control system is provided which controls the operation of all engine components.

In addition to providing for exhaust gas emission limits of internal combustion engines, new laws and rules also set limits for the evaporation emissions of the motor vehicles, which originate mainly in the fuel system of the internal combustion engine, the transmission and the air conditioning system of the motor vehicle. These limit values have meanwhile reached a very low level so that also the evaporative emissions of the engine itself are becoming relevant. The evaporative emissions are tested for example by a so-called SHED-test which represents a test type IV according to the EG guide line 70/220 in the version 96/99 for maintaining limit values for evaporative emissions.

In order to reduce engine emissions after shutdown of the engine, DE 197 35 455 C1, which is assigned to the assignee of the present application, discloses for example a system wherein, after shutdown of the engine, and an examination whether the fuel injection is shut off, the throttle valve in the air intake duct is essentially fully opened in order to provide for venting of the combustion chambers and the exhaust gas system by fresh air admitted in order to ventilate emissions from the engine to the catalytic converter for combustion in the still hot catalytic converter.

Based on this state of the art, it is the object of the present invention to provide an internal combustion engine in which the evaporative emissions originating in the engine are substantially reduced in a simple and reliable manner. It is also an object of the invention to provide a method for the operation of such an engine by which the evaporative emissions of the engine are reduced in a simple and reliable manner.

### SUMMARY OF THE INVENTION

In an internal combustion engine for a motor vehicle, comprising a starter system and a control system for controlling the internal combustion engine, the control system of the internal combustion engine is configured for a defined coast down of the internal combustion engine, by means of which pollutants that are left in the internal combustion engine are fed to the catalytic converter system for afterburning, while the control system actuates the starter system for a specific first period of time following a last combustion event in a combustion chamber.

With the actuation of the starter system after the last combustion event in a combustion chamber of the internal combustion engine after the operator has shut down the engine, the engine is turned over for a certain period after engine shutdown. With trailing engine operation, rests of hydrocarbon deposits in the intake or combustion areas of the internal combustion engine are supplied to the still hot catalytic converter and are catalytically combusted therein. As a result, rests of hydrocarbon deposits in the engine are greatly reduced in this way the engine can be brought into an almost emission free state in which evaporative emissions are substantially reduced.

In a particularly preferred embodiment of the invention, the internal combustion engine further includes at least one supply arrangement for supplying secondary air to the engine with a valve arrangement which is controllable preferably by the engine control unit. The engine control unit controls the arrangement for supplying secondary air preferably in such a way that secondary air is admitted to the combustion chambers after a last combustion event for a certain second period. The supply of secondary air to the internal combustion engine provides for an additional flushing of the respective engine components so that the pollutants still present on these components and moved forward by the turning over of the engine are supplied to the catalytic converter for combustion therein.

The secondary air is supplied for example to the inlet passages, the combustion chambers, the exhaust passages the exhaust gas recirculation system, the catalytic converter system etc. of the internal combustion engine. The secondary air can be supplied for example by a special construction of the exhaust manifold or the cylinder head arrangement, as it is known for example from De 198 32 627 A1 or DE 196 42 685 A1 of the Assignee of the present invention.

Preferably, the engine control unit controls the starter system in such a way that, after completion of the flushing of the engine by secondary air, the starter system, that is, particularly the piston in the cylinders are positioned for optimal engine startup.

In order to increase the flushing effect for the various components of the internal combustion engine with or without the admission of secondary air in a particularly preferred embodiment a throttle is provided in the intake duct which is controlled by the engine control unit so that, after the last combination occurrence in a combustion chamber, the throttle is closed. With the throttle closed a vacuum is generated in the engine during the turning over of the engine after engine shutdown, whereby hydrocarbon depositions are evaporated from crevices and recesses for example in the transitions in the cylinder head, the valve seats and the piston rings. The contaminations released in this manner are supplied by turning over of the engine together with the admitted secondary air to the catalytic converter for combustion.

The throttle is preferably provided with seal elements such that it can be closed in an essentially gas-tight manner.

In order to prevent evaporation and emission of hydrocarbons during the subsequent shutdown period of the internal combustion engine into the exhaust system, the throttle valve is preferably closed by the engine control unit and remains closed also after the predetermined first period.

In accordance with a second aspect of the invention, the object mentioned above is achieved by the method of the invention wherein after the last combustion event in one of the cylinders, the starter system is activated for a certain first period so that the engine is turned over and the evaporative emissions of the engine formed after shutdown are substantially reduced as explained above.

Preferably, secondary air is supplied to the engine after the last combustion event for a certain second period in order to flush all the evaporated components from the engine and to carry any pollution compounds to the catalytic converter which, after the shutdown of the engine is still hot and operative for the combustion of the pollutants.

Preferably, a throttle flap is provided in the intake duct which is closed after a last combustion event in a combustion chamber so that, by the shutdown of the engine (while the engine is coasting down), a vacuum is generated in the engine with the advantageous result mentioned above.

The throttle flap preferably remains closed also after completion of the engine coast down so that escape of any evaporated hydrocarbon deposits from the intake duct is prevented.

The invention will be described below in greater detail on the basis of the accompanying drawings.

### BRIEF DESCRIPTION OF THE DRAWINGS

FIG. 1 shows schematically a preferred embodiment of the internal combustion engine according to the invention, and

FIGS. 2a to 2f show operational time diagrams for an explanation of the operation of the internal combustion engine of FIG. 1.

### DESCRIPTION OF PARTICULAR EMBODIMENTS

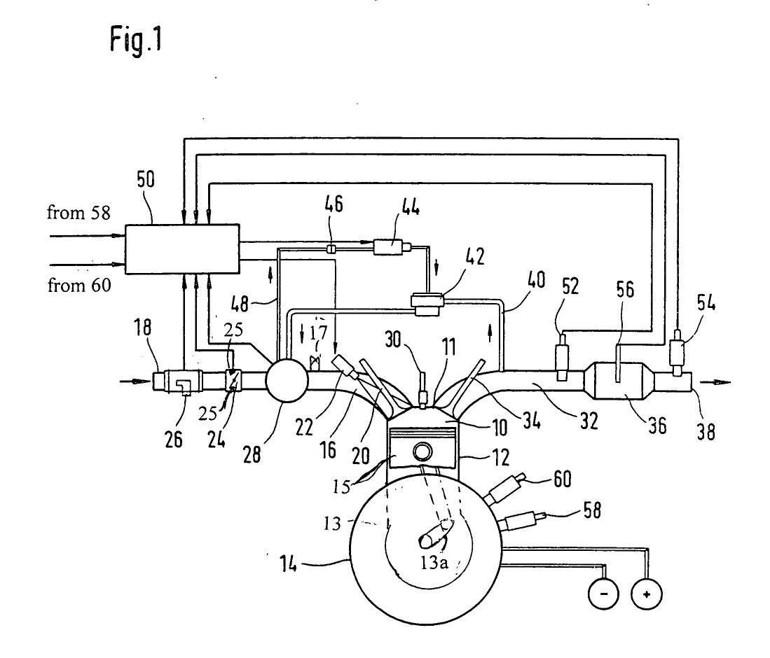

FIG. 1 is a schematic representation of an internal combustion engine (particularly a piston engine 1) of a motor vehicle. The design is basically the same as that of a conventional internal combustion engine so that a detailed explanation of the design and the operation of the individual components is not necessary.

An essential part of the internal combustion engine is the cylinder head 11. The cylinder head 11 is mounted, in the common way, by way of a cylinder head gasket onto a cylinder block 12 with a crankcase 13 which includes a crankshaft 13a connected to pistons 15 disposed in the cylinder block 12 in FIG. 1. The longitudinal axis of the engine extends normal to the drawing plane so that only one piston is visible in the cylinder block 12. Normally, the cylinder block 12 includes a plurality of cylinders and the cylinder head 11 extends over all the cylinders and defines several combustion chambers 10. The crankshaft 13a supported in the crankcase 13 is coupled to a starter system or respectively, a starter/generator system 14, which is used in a well-known manner for starting the engine.

The combustion chambers 10 are in communication with an induction duct 18 by intake passages 16. The intake passages 16 can be closed or opened by inlet valves 20, which are actuated by a camshaft which is not shown. In the intake passages fuel injection valves 22 are provided for the injection of fuel for generating a fuel/air mixture. The air intake duct includes a throttle flap 24 for controlling the air supply to the cylinders, a hot film air mass flow meter 20 and an intake air manifold 28 to which an exhaust gas return line of the exhaust gas recirculation system is connected. The final air mixture inducted into the combustion chambers is ignited by a spark plug 30.

The exhaust gases formed by the combustion of the fuel/air mixture in the combustion chambers 10 are discharged via outlet passages 32. Like the inlet passages 16, the outlet passages 32 can be opened and closed by outlet valves 34 which are controlled by a camshaft which is not shown. The exhaust gases discharged from the combustion chambers 10 are conducted first to a catalytic converter system 36 and are then discharged to the environment via an exhaust system 38. For a further reduction of contaminants in the exhaust gases discharged to the environment, the exhaust gases discharged from the combustion chambers 10 are partially re-circulated via an exhaust gas recirculation line 40 to the air intake duct or the air intake passages 16 for one more pass through the combustion chambers 10. The exhaust gas recirculation system comprises, in addition to the exhaust gas recirculation line 40, an exhaust gas recirculation valve 42, an electro-pneumatic switch-over valve 44 and a vacuum control arrangement 48 in communication, via a check valve 46, with the electro-pneumatic switchover valve 44 for controlling the switch-over valve 44 as shown in FIG. 1.

All the components of the internal combustion engine are controlled by a control unit 50. To this end, the control unit 50 is connected not only to the components of the internal combustion engine already mentioned but also to a multitude of sensor arrangements. Part of the sensor arrangements are for example the hot film air mass flow meter 26, a pressure sensor in the intake manifold 28, a first lambda probe 52 for determining the oxygen content in the exhaust gases ahead of the catalytic converter system 32, a second lambda probe 54 for determining the oxygen content of the exhaust gases after passing through the catalytic converter system 36, a sensor arrangement 56 for determining the condition of the catalytic converter system 36, an engine rpm sensor 58, a sensor arrangement 60 for determining the crank angle of the crankshaft etc.

In the example of the internal combustion engine as shown in FIG. 1, the control unit 50 further operates the starter system 14 after a last combustion event in a combustion chamber 10, for example after initiation of the engine shut down by an operator. Whereas in conventional internal combustion engines the rotational energy results in a certain coast down of the engine following the initiation of the engine shutdown, by actuating the starter system 14, in the present case the engine coast down is extended for a predetermined period.

Preferably, the coast down of the internal combustion engine by actuation of the starter system 14 is performed depending on the charge state of the battery of the vehicle that is, respectively, on the electrical power supply system of the vehicle. In other words, if the battery is already weak such an extended coast down of the engine can be omitted in order to preserve battery power.

With the predetermined coast down of the internal combustion engine, hydrocarbons, which are still present particularly in the engine inlet passages 16, the combustion chambers 10 and the exhaust passages 32, are conducted to the still hot catalytic converter system 36, where they are combusted. In this way, the contaminants remaining in the internal combustion engine after engine shut down are substantially reduced whereby the evaporative emissions of the internal combustion engine are reduced which emissions are determined for example by the so-called SHED-tests.

Furthermore, the throttle flap 24 in the air intake duct 18 is provided with seal elements 25 such that the throttle flap 24 can be closed in a gastight manner. If the throttle flap 24 is closed during the coast-down of the engine as described above a vacuum is generated in the engine during the starter-supported coast down of the engine described earlier. The vacuum enhances the evaporation of hydrocarbons from crevices and recesses for example in the transition areas of the inlet duct to the cylinder head, the valve seats and the piston rings. The hydrocarbons released in this way are immediately conducted during the coast down of the engine to the catalytic converter system 36 and burnt therein.

The control unit 50 controls the throttle flap 24 furthermore in such a way that the throttle flap 24 remains closed after completion of the coast down procedure that is for the whole period in which the engine remains shut down. In this way, emission of any contaminants still present in the intake duct 18, the inlet passages 16, the combustion chambers 10, the exhaust passages 32, the catalytic converter system and the exhaust system 38 into the environment is prevented. Also for this purpose, it is advantageous if the throttle flap is provided with the seal element 25 for tightly closing the intake duct 18.

Furthermore, the internal combustion engine as shown in FIG. 1 includes a number of supply devices 17 for the admission of secondary air which may be arranged for example in the area of the inlet passages 16, the combustion chambers 10 and the exhaust passages 32. However, the secondary admission locations are not limited to the areas mentioned. They may also be incorporated into the exhaust gas recirculation system.

The admission devices for secondary air may be provided in the form of special inlet bores or inlet pipes which are in communication with particular components of the internal combustion engine and which can be opened and closed by suitable valves, which preferably are also controlled by the engine control unit 50. Supply arrangements for secondary air are basically known in engines for other purposes and can be used also in connection with the internal combustion engine shown in FIG. 1. Such air supply arrangements are for example disclosed in DE 196 42 685 A1 and DE 198 32 672 A1. But the secondary air supply arrangements are not limited to the arrangements as disclosed in these two patent publications.

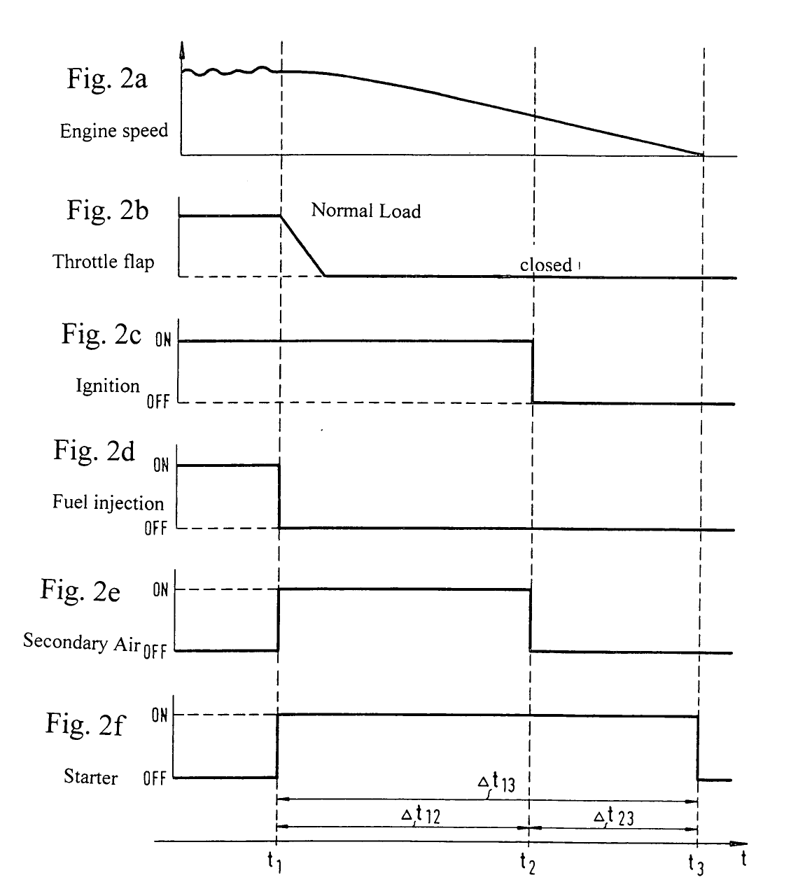

The operation of the internal combustion engine described above will now be described on the basis of the time diagrams shown in FIGS. 2a to 2f.

FIG. 2a shows the engine speed (rpm) depending on time during coast down. FIG. 2b shows the position of the throttle flap 24 over time during engine coast down. FIG. 2c shows the operational state of the ignition (on-off) during engine coast down. FIG. 2d shows the operational state of the fuel injection system (on-off) during engine coast down. FIG. 2a shows the operation of the secondary air supply system (on-off) during the coast down period of the engine, and FIG. 2f shows the operation of the starter system during engine coast down.

At the time t₁, the vehicle operator initiates shut down of the internal combustion engine by turning the ignition key off. At this point, the control unit 5 moves the throttle flap 24 from its normal load position to its closed position (FIG. 2b). Fuel injection is terminated as in conventional engines (FIG. 2d), the starter system 14 is switched on (FIG. 2f) and the secondary air supply is switched on (FIG. 2c). By the actuation of the starter system 14, the engine speed is only slowly reduced at a well defined rate (FIG. 2a). The ignition remains switched on (FIG. 2c).

The coast down of the engine initiated at the point in time t₁ occurs over a predetermined period Δt₁₂=t₂-t₁. After this period Δt₁₂, at the point in time t₂ the secondary air supply (FIG. 2e) and the ignition are shut off (FIG. 2c). The throttle flap 24 remains closed (FIG. 2b). Fuel injection remains shut off (FIG. 2d) and the starter system remains activated (FIG. 2f). This state remains in effect for another period Δt₂₃=t₃−t₂. During this period Δt₂₃, the starter system 14 slows the engine down to zero U/min (FIG. 2a) and the engine is brought into an optimum startup position. As mentioned earlier, the throttle flap 24 remains closed preferably also after termination of the coast down procedure and the engine is positioned or set for fast startup.

The whole period Δl3 during which the starter system 14 is in operation is designated as the first period and the period Δt₁₂ during which the secondary air supply system is switched on is designated the second period. As apparent from FIG. 2, the second period Δt₁₂ during which the secondary air supply is switched on is shorter than the first period Δt₁₃ during which the starter system 14 is activated.

1. An internal combustion engine, comprising a cylinder head (11), a crankcase (13) with a cylinder block (12) on which the cylinder head (11) is mounted and in which a piston (15) is disposed, so as to form a combustion chamber (10) between the piston (15) and the cylinder head (11), the cylinder head (11) including an air inlet passage (16), an air intake duct connected to the air inlet passage (16) for supplying a fuel/air mixture to the combustion chamber (10), an exhaust gas outlet passage (32) connected to an exhaust gas discharge duct for the discharge of exhaust gases from the combustion chamber (10), a crankshaft (13a) rotatably supported in the crankcase (13) and a starter system (14) connected to the crankshaft (13a) for rotating the crankshaft (13a) of the engine and a control unit (50) for actuating the starter system (14) so that, following a last combustion event upon initiation of the shutdown of the engine, the starter system (14) is activated for a first period (Δt₁₃) for controlling the engine coast down.

2. An internal combustion engine according to claim 1, wherein the internal combustion engine comprises at least one device (17) for the admission of secondary air to the engine, the at least one secondary air admission device including a valve connected to the control unit (50) for controlling operation of the secondary air admission device (17).

3. An internal combustion engine according to claim 2, wherein the secondary air admission device (17) is controlled by the engine control unit (50) so as to be opened after the last combustion event at the time (t₁) to admit secondary air to at least one combustion chamber (10) for a second period (Δt₁₂).

4. An internal combustion engine according to claim 2, wherein the secondary admission devices are provided for supplying secondary air to at least one of an inlet passage (16), a combustion chamber (11), an exhaust duct (32) an exhaust gas recirculation line (40) and the catalytic converter system (36).

5. An internal combustion engine according to claim 3, wherein the second period (Δt₁₂) of secondary air admission is shorter than the first period (Δt₁₃) of starter system activation.

6. An internal combustion engine according to claim 3, wherein the starter system (14) is operated by the control unit (50) during a certain third period (Δt₂₃) to bring the engine to an optimal startup position.

7. An internal combustion engine according to claim 1, wherein a throttle flap (24) is arranged in the air intake duct (18) and the engine control unit (50) causes closing of the throttle flap (24) after the last combustion event in a combustion chamber (10) at the point in time (t₁) of engine shut down.

8. An internal combustion engine according to claim 7, wherein the throttle flap (24) is provided with seal elements (25) and the engine control unit (50) controls the valve flap (24) so as to be moved, after the last combustion event in a combustion chamber (11), into a gastight engagement with the seal elements (25).

9. An internal combustion engine according to claim 7, wherein the throttle flap is controlled by the control unit (50) so as to remain closed also after the first period (Δt₁₃).

10. A method of operating an internal combustion engine comprising a cylinder head (11), a crankcase (13) with a cylinder block (12) on which the cylinder head (11) is mounted and in which a piston (15) is disposed, so as to form a combustion chamber (10) between the piston (15) and the cylinder head (11), the cylinder head (11) including an air inlet passage (16), an air intake duct connected to the air inlet passage (16) for supplying a fuel/air mixture to the combustion chamber (10), an exhaust gas outlet passage (32) connected to an exhaust gas discharge duct for the discharge of exhaust gases from the combustion chamber (10), a crankshaft (13a) rotatably supported in the crankcase (13) and a starter system (14) connected to the crankshaft (13a) for rotating the crankshaft (13a) of the engine and a control unit (50) for actuating the starter system (14) wherein, after a last combustion event in any of the combustion chambers (10) of the engine, the starter system (14) is operated for a period (Δt₁₃) to continue to rotate the engine crankshaft for pumping air through the engine.

11. A method according to claim 10, wherein secondary air is admitted to the engine after the last combustion event at the point in time (t₁) of engine shutdown for a second period (Δt₁₂).

12. A method according to claim 11, wherein the secondary air is supplied at least to one of the inlet passage (16), the combustion chamber (11), the exhaust passage (32), an exhaust gas recirculation line (40) and a catalytic converter system (36) of the internal combustion engine.

13. A method according to claim 11, wherein the second period (Δt₁₂) of secondary air admission is shorter than the first period (Δt₁₃) of the starter activation.

14. A method according to claim 11, wherein the starter system (14) is operated by the control unit (50) during a certain third period (Δt₂₃) at the end of the certain first period (Δt₂₃) to bring the engine to an optimal startup position.

15. A method according to claim 10, wherein a throttle flap (24) in the air intake duct (18) of the internal combustion engine is closed after a last combustion event at the time (t₁) of engine shut down initiation.

16. A method according to claim 15, wherein the throttle flap (24) is closed in a gas-tight manner to generate a vacuum in the engine during engine coast down.

17. A method according to claim 15, wherein the throttle flap (24) is maintained closed also after the certain first period (Δt₁₃) in order to prevent the escape of pollutants from the engine while the engine is shut down.
